(19) United States
(12) Patent Application Publication
(10) Pub. No.: US 2015/0315324 A1
(43) Pub. Date: Nov. 5, 2015

(54) TERMINAL BORINIC ACID GROUP-MODIFIED POLYMER, METHOD OF MANUFACTURING THE SAME AND RUBBER COMPOSITION CONTAINING THE SAME

(71) Applicant: The Yokohama Rubber Co., Ltd., Tokyo (JP)

(72) Inventors: Kazuya Uenishi, Kanagawa (JP); Yusuke Tanabe, Kanagawa (JP); Misao Hiza, Kanagawa (JP)

(21) Appl. No.: 14/650,069

(22) PCT Filed: Dec. 6, 2013
(86) PCT No.: PCT/JP2013/082811

§ 371 Date: Jun. 5, 2015

(30) Foreign Application Priority Data
Dec. 6, 2012 (JP) 2012-267061

(51) Int. Cl. C08F 236/10

(52) U.S. Cl. CPC C08F 236/10

(57) ABSTRACT

Provided is a terminal borinic acid group-modified polymer having a borinic acid group at least at a molecular terminus thereof, comprising a polymer of at least one of a styrene monomer and a diene monomer. The above terminal borinic acid group-modified polymer may be manufactured by performing a polymerization reaction of at least one of a styrene monomer and a diene monomer in the presence of an anionic polymerization initiator, and then adding a cyclic boronic anhydride to quench the polymerization reaction. When the resulting terminal borinic acid group-modified polymer is added to a silica-containing rubber composition for automobile pneumatic tires as a component thereof, the dispersibility of silica compounded therein can be improved, fully achieving a performance of a good balance between reduced rolling resistance inherent in silica and stability on a wet road.

### TECHNICAL FIELD

The present invention relates to a terminal borinic acid group-modified polymer, a method of manufacturing the terminal borinic acid group-modified polymer and a rubber composition containing the terminal borinic acid group-modified polymer. More particularly, the present invention relates to a terminal borinic acid group-modified polymer used as a compounding agent for an automobile pneumatic tire composition and the like which has an improved dispersibility of silica, a method of manufacturing the terminal borinic acid group-modified polymer and a rubber composition containing the terminal borinic acid group-modified polymer.

### BACKGROUND ART

Various performances required for automobile pneumatic tires include reduced rolling resistance, stability on a wet road and the like. As a method that can balance these properties, silica is compounded in a rubber composition for tires as a reinforcing filler. However, the following problem has been encountered: although silica is compounded in a rubber composition for tires, the dispersibility of silica into the composition is low. Therefore, even in a case where a large amount of silica can be added, the effect of silica can not be fully obtained.

Patent Document 1 describes a method of manufacturing an elastomer/filler composite useful as a tire component and the like, the method comprising forming in situ a reinforcement filler from a precursor thereof in an elastomer host material to uniformly disperse the reinforcement filler. In order to compound silica as a filler, a reaction from a filler precursor is required in Patent Document 1.

Further, in Patent Document 2, in order to allow a rubber-like living polymer to become more compatible with a filler such as carbon black and silica, a reaction product of p-boronic acid ester of aniline with a carbonyl compound such as aldehyde and ketone is used as a functionalizing agent useful for functionalizing these. In this case, there is a limitation for the terminal structure to be introduced.

Further, Patent Documents 3 to 4 describe a modified polymer used as a compatible modifier, or an adherence conferring agent, wherein a boronic acid group or a boron-containing group which can be converted into a boronic acid group in the presence of water is introduced into an olefinic double bond in a styrene-hydrogenated diene block copolymer at a side chain of the block copolymer through an addition reaction.

In Patent Documents 3 to 4, a polymer is modified. In contrast, Patent Document 5 describes that a vinyl based polymer or a diene based polymer having a functional group comprising a polyhydric alcohol ester of boronic acid can be obtained by performing a polymerization reaction of styrene in the presence of boronic acid ester using an anionic polymerization initiator such as n-butyl lithium and sec-butyl lithium. In this case, 3-mercaptopropyl boronic acid ethyleneglycol ester as a polyhydric alcohol ester of boronic acid is added from the beginning of the polymerization reaction. Patent Document 5 also states that the resulting polymer does not develop an increase in viscosity when melt-kneading with a thermoplastic resin having a hydroxy group, in particular EVA, and shows a stable melting behavior, and that it is useful as a compatible modifying agent.

### PRIOR ART DOCUMENTS

### Patent Literature

Patent Document 1: JP-A-2000-273191

Patent Document 2: JP-A-2009-221203

Patent Document 3: JP-A-2002-308932

Patent Document 4: JP-A-2006-176788

Patent Document 5: JP-A-2001-40034

### OUTLINE OF THE INVENTION

### Problem to be Solved by the Invention

An object of the present invention is to provide a terminal borinic acid group-modified polymer used as a compounding agent for an automobile pneumatic tire composition and the like which has an improved dispersibility of silica, a method of manufacturing the above modified polymer, and a rubber composition containing the above modified polymer.

### Means for Solving the Problem

The present invention provides a terminal borinic acid group-modified polymer having a borinic acid group at least at a molecular terminus thereof, comprising a polymer of at least one of a styrene monomer and a diene monomer. The above terminal borinic acid group-modified polymer may be manufactured by polymerizing at least one of a styrene monomer and a diene monomer in the presence of an anionic polymerization initiator, and then adding a cyclic boronic anhydride to quench the polymerization reaction. The resulting modified polymer is to be compounded in a diene based rubber.

### Effect of the Invention

In the terminal borinic acid group-modified polymer according to the present invention, a borinic acid group as a functional group on a benzene ring can be easily introduced into a molecular terminus using a cyclic boronic anhydride, in particular phenylboronic anhydride or a p-methyl, p-fluoro substitution compound thereof and the like as a quencher of the polymerization reaction.

When the resulting terminal borinic acid group-modified polymer is added to a silica-containing rubber composition for automobile pneumatic tires as a component thereof, the dispersibility of silica compounded therein can be improved, fully achieving a performance of a good balance between reduced rolling resistance inherent in silica and stability on a wet road. This rubber composition for tires can be suitably used for forming a cap tread part, a side tread part and the like of a pneumatic tire.

### EMBODIMENTS FOR CARRYING OUT THE INVENTION

The terminal borinic acid group-modified polymer may be manufactured by performing a polymerization reaction of at least one of a styrene monomer, diene and a diene monomer in the presence of an anionic polymerization initiator, and then quenching the polymerization reaction by adding a cyclic boronic anhydride.

As the styrene monomer, used are styrene, a-methyl styrene, p-methyl styrene and the like. As the diene monomer, used are 1,3-butadiene, isoprene, chloroprene and the like, and 1,3-butadiene and isoprene are preferably used, and 1,3-butadiene is more preferably used. These styrene monomers and diene monomers may be used alone, or may be used so that a copolymer of these is formed. The resulting copolymer is usually a random copolymer, but may also be a block copolymer.

A polymerization reaction is performed in the presence of an anionic polymerization initiator such as n-butyl lithium and sec-butyl lithium. The amount of an anionic polymerization initiator is in a rate of about 0.0001 to 5 mol %, preferably about 0.0005 to 0.5 mol % relative to the molar quantity of a monomer (mixture) used.

To the polymerization reaction system, added is 2,2-ditetrahydrofuryl propane, N,N,N′,N′-tetramethylethylenediamine and the like which are used at a rate of about 10 to 300 mol %, preferably about 50 to 200 mol % relative to the molar quantity of an initiator used. These compounds serve as anion initiators and activators for a growing species or randomizers during copolymerization when a nonpolar solvent such as cyclohexane or methylcyclohexane is used for the polymerization reaction.

The polymerization reaction may be performed, for example, under the conditions of about −100 to 100° C., usually a room temperature to 70° C. for about 1 minute to 5 hours using a hydrocarbon based solvent such as cyclohexane, methylcyclohexane, toluene and tetrahydrofuran. Subsequently, a cyclic boronic anhydride, for example, phenylboronic anhydride, or p-methyl or p-fluoro substitution compound thereof and the like are added to the polymerization reaction system to quench the polymerization reaction. The amount of a cyclic boronic anhydride is an amount sufficient for introducing a terminal group of a produced polymer, and the cyclic boronic anhydride is used, for example, at a rate of about 100 to 1000 mol %, preferably about 100 to 400 mol % relative to the molar quantity of an anion initiator used.

Therefore, a cyclic boronic anhydride allows a borinic acid group (a RR′BOH group) to be formed at least at a terminus of the polymer molecule. For example, in a case where styrene and 1,3-butadiene are used as monomers, or 1,3-butadiene is used as a monomer, and phenylboronic anhydride is used for forming a terminal group, a reaction is performed according to the following formula to form a modified polymer having a terminal borinic acid group along with a —[B(R₁)O]n- bond (n: 0 to 50). Note that the resulting terminal borinic acid-modified polymer has a number average molecular weight Mn of 1,000 to 10,000,000, generally 3,000 to 1,000,000.

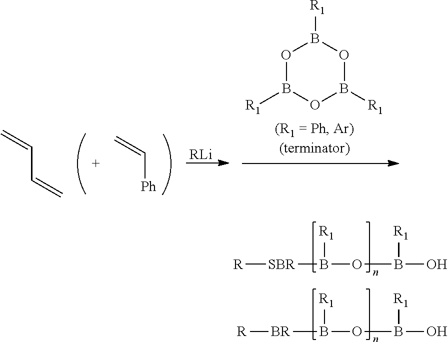

The resulting terminal borinic acid-modified polymer is to be compounded in a diene based rubber, in particular, a silica-containing diene based rubber. The terminal borinic acid-modified polymer is to be used at a rate of 0.1 to 30 parts by mass, preferably 1 to 10 parts by mass, relative to the total amount of 100 parts by mass including a diene based rubber. In a case where the ratio of the terminal borinic acid-modified polymer used is less than this, desired modification effects may not be obtained. On the other hand, in a case where it is used at more than this ratio, processability of an unvulcanized rubber may be decreased.

As the diene based rubber, natural rubber (NR), isoprene rubber (IR), butadiene rubber (BR), chloroprene rubber (CR), butyl rubber (IIR), nitrile rubber (NBR), styrene-butadiene rubber (SBR) and the like can be used alone or as a blended rubber, and preferably NR, BR or a blended rubber thereof can be used. As SBR, any of emulsion-polymerized SBR (E-SBR) and solution-polymerized SBR (S-SBR) can be used.

Silica or both silica and carbon black may be added to a diene based rubber composition in an amount of 10 to 150 parts by mass, preferably 30 to 130 parts by mass per 100 parts by mass of a diene based rubber containing a terminal borinic acid-modified polymer. The addition of these fillers, in particular silica, can reduce rolling resistance and the like. Contrary to this, however, when used at more than this ratio, rolling resistance and the like may be deteriorated.

Used is a silica having a BET specific surface area (in accordance with ASTM D1993-03) of 70 to 200 m²/g, preferably 70 to 190 m²/g. These are a dry-process silica manufactured by pyrolysis of silicon halides or organosilicon compounds and the like and a wet-process silica manufactured by acid decomposition of sodium silicate and the like. A wet-process silica is preferably used in view of cost and performance. Actually, commercially available products currently on the market for use in the rubber industry can be used as they are.

In order to enhance characteristics required for silica and the dispersibility in a diene based rubber (silica has a poor affinity with rubber polymers, and also has a characteristic in which silica mutually forms a hydrogen bond in a rubber through a silanol group, resulting in a decreased dispersibility of silica into the rubber), a silane coupling agent is to be compounded in an amount of 1 to 20 parts by mass, preferably 1 to 10 parts by mass per 100 parts by mass of a diene based rubber containing a terminal borinic acid modified-polymer. As the silane coupling agent, the following are preferably used: bis(trialkoxysilylpropyl)sulfide which has an alkoxysilyl group that reacts with a silanol group on the surface of silica and a sulfur chain that reacts with a polymer,

(RO)₃Si(CH₂)₃—(S)ₙ—(CH₂)₃Si(OR)₃
R: an alkyl group having 1 to 2 carbon atoms
n: an integer of 1 to 4,
   for example, bis(3-triethoxysilylpropyl)tetrasulfide, bis(2-triethoxysilylethyl)tetrasulfide, bis(3-trimethoxysilylpropyl)tetrasulfide, bis(3-triethoxysilylpropyl) disulfide and the like.

As the carbon black, commonly used is furnace black such as SAF, ISAF, HAF, FEF, GPF and SRF. Such a carbon black, which is an effective component for forming a tread part, in particular a cap tread part, of a pneumatic tire, is used along with silica in a rate of 1 to 10 parts by mass per 100 parts by mass of a diene based rubber containing a terminal borinic acid-modified polymer.

In a rubber composition having each component described above as an essential component, sulfur as a vulcanizing agent and any one or more of vulcanization accelerators such as thiazole based agents (MBT, MBTS, ZnMBT and the like), sulfenamide based agents (CBS, DCBS, BBS and the like), guanidine based agents (DPG, DOTG, OTBG and the like), thiuram based agents (TMTD, TMTM, TBzTD, TETD, TBTD and the like), dithiocarbamate based agents (ZTC, NaBDC and the like) and xanthate based agents (ZnBX and the like), preferably a sulfur-containing vulcanization accelerator are to be compounded Further, other compounding agents commonly used as compounding agents for rubber may be appropriately compounded if desired, including, for example, a reinforcing agent or a filler such talc, clay, graphite and calcium silicate, a processing aid such as stearic acid; zinc oxide, a softener, a plasticizers, an antioxidant and the like.

A composition can be prepared by kneading with a kneading machine or a mixer such as a kneader and a Banbury mixer, an open roll and the like by a general method. After molded into a predetermined shape, the resulting composition is vulcanized at a vulcanizing temperature depending on the types of diene based rubber, vulcanizing agent, vulcanization accelerator used and a blending ratio thereof to form a tread part of a pneumatic tire and the like.

### EXAMPLES

Next, the present invention will be described with reference to Examples.

### Example 1

To a 100 ml two-necked flask,

| | | |
|---|---|---|
| cyclohexane (Kanto Chemical Co., Inc.) | 7 | ml |
| 2,2-ditetrahydrofuryl propane | 0.243 | g (1.32 mmol) |
| (Tokyo Chemical Industry Co., Ltd.) | | |
| n-BuLi hexane solution | 2 | ml (3.14 mmol) |
| (Kanto Chemical Co., Inc.; | | |
| concentration: 1.57 mol/L) | | |
| were charged under the conditions | 5.59 | g (53.7 mmol) |
| of room temperature, | | |
| and to the resulting solution, | | |
| styrene (Kanto Chemical Co., Inc.) | | |

was added dropwise at 0° C., and stirred for 3 hours under the conditions of room temperature. Subsequently,

A solution of 1.55 g (4.97 mmol) phenylboronic anhydride (Hokko Chemical Industry Co., Ltd.) in 10 ml tetrahydrofuran (Kanto Chemical Co., Inc.) was added to quench the polymerization reaction.

Volatile components were distilled off from the resulting reaction mixture, and the residue was dissolved in 30 ml of tetrahydrofuran, and then added dropwise to 200 ml of methanol to separate a methanol insoluble component and a methanol soluble component. The same procedure was repeated twice for the insoluble component, and volatile components were distilled off to obtain 5.31 g (the yield was 95% relative to the charged monomer) of a white solid product having a terminal-B(C₆H₅)OH group (a terminal modified polystyrene).

Mn: 4510

Mn (the number average molecular weight) was measured by SEC (size exclusion type chromatography), and a value of Mn was estimated in terms of a polystyrene equivalent molecular weight.

PDI: 1.2

PDI (polydispersity index) was calculated as Mw/Mn using a value of Mw (the weight average molecular weight) measured by SEC and Mn. A value of PDI closer to 1 indicates that a polymer having a controlled molecular weight distribution was obtained.

Rf: 0.58

A value of Rf was measured by TLC (thin layer chromatography) with a silica plate, and a smaller value indicates a higher affinity with silica.

¹H-NMR (CDCl₃, 20° C.): δ=7.8 (br)

7.4 to 6.9 (br)

6.9 to 6.7 (br)

6.7 to 6.2 (br)

2.3 to 2.0 (br)

2.0 to 1.2 (br)

1.2 to 0.9 (br)

0.8 to 0.7 (br)

### Example 2

A white solid product having a terminal-B(p-CH₃C₆H₄)OH group (a terminal modified polystyrene) 5.21 g (yield: 92%) was obtained as in Example 1 except that the amounts of 2,2-ditetrahydrofuryl propane and styrene were changed to 0.245 g (1.33 mmol) and 5.66 g (54.3 mmol), respectively, and 1.89 g (5.34 mmol) of p-methylphenylboronic anhydride (Hokko Chemical Industry Co., Ltd.) was used instead of phenylboronic anhydride.

Mn: 3590

PDI: 1.2

Rf: 0.65

¹H-NMR (CDCl₃, 20° C.): δ=7.6 (br)

7.4 to 6.9 (br)

6.9 to 6.7 (br)

6.7 to 6.2 (br)

2.3 to 2.0 (br)

2.0 to 1.2 (br)

1.2 to 0.9 (br)

0.8 to 0.7 (br)

### Example 3

A white solid product having a terminal-B(p-FC₆H₄)OH group (a terminal modified polystyrene) 5.19 g (yield: 91%) was obtained as in Example 1 except that the amounts of 2,2-ditetrahydrofuryl propane and styrene were changed to 0.245 g (1.33 mmol) and 5.70 g (54.7 mmol) respectively, and 1.64 g (4.48 mmol) of p-fluorophenylboronic anhydride (Hokko Chemical Industry Co., Ltd.) was used instead of phenylboronic anhydride.

Mn: 3370

PDI: 1.2

Rf: 0.76

¹H-NMR (CDCl₃, 20° C.): δ=7.9 (br)

7.5 (br)

7.4 to 6.9 (br)

6.9 to 6.7 (br)

6.7 to 6.2 (br)

2.3 to 2.0 (br)

2.0 to 1.2 (br)

1.2 to 0.9 (br)

0.8 to 0.7 (br)

### Example 4

A colorless viscous liquid product having a terminal-B(C₆H₅)OH group (a terminal modified polybutadiene) 2.11 g (yield: 84%) was obtained as in Example 1 except that the amounts of 2,2-ditetrahydrofuryl propane, an n-hexane solution of n-BuLi (concentration: 1.50 mol/L) and phenylboronic anhydride were changed to 0.218 g (1.18 mmol), 1 ml (1.50 mmol) and 0.949 g (3.04 mmol), respectively, and 16.8 g (46.6 mmol) of a 15 weight % n-hexane solution of 1,3-butadiene was used instead of styrene.

Mn: 9890

PDI: 1.0

Rf: 0.71

¹H-NMR (CDCl₃, 20° C.): δ=7.8 (br)

7.5 to 7.4 (br)

5.9 to 5.3 (br)

5.1 to 4.8 (br)

2.7 to 1.8 (br)

1.8 to 0.9 (br)

0.8 to 0.7 (br)

### Example 5

A colorless viscous liquid product having a terminal-B(p-CH₃C₆H₄)OH group (a terminal modified polybutadiene) 2.24 g (yield: 91%) was obtained as in Example 4 except that the amounts of 2,2-ditetrahydrofuryl propane, n-BuLi and an n-hexane solution of 1,3-butadiene were changed to 0.208 g (1.13 mmol), 2 ml (3.00 mmol) and 16.4 g (45.5 mmol), respectively, and 1.93 g (5.45 mmol) of p-methylphenylboronic anhydride was used instead of phenylboronic anhydride.

Mn: 5620

PDI: 1.1

Rf: 0.76

¹H-NMR (CDCl₃, 20° C.): δ=7.6 (br)

7.4 (br)

5.9 to 5.3 (br)

5.1 to 4.7 (br)

2.8 to 1.8 (br)

1.7 to 0.9 (br)

0.9 to 0.7 (br)

### Example 6

A colorless viscous liquid product having a terminal-B(p-FC₆H₄)OH group (a terminal modified polybutadiene) 2.19 g (yield: 88%) was obtained as in Example 4 except that the amounts of 2,2-ditetrahydrofuryl propane and an n-hexane solution of 1,3-butadiene were changed to 0.283 g (1.53 mmol) and 16.6 g (46.0 mmol), respectively, and 0.880 g (2.41 mmol) of p-fluorophenylboronic anhydride was used instead of phenylboronic anhydride.

Mn: 3380

PDI: 1.1

Rf: 0.70

¹H-NMR (CDCl₃, 20° C.): δ=7.9 (br)

7.5 (br)

5.8 to 5.2 (br)

5.1 to 4.8 (br)

2.9 to 1.7 (br)

1.7 to 0.8 (br)

0.8 to 0.7 (br)

### Example 7

A colorless viscous liquid product having a terminal-B(C₆H₅)OH group (a terminal modified polystyrene-butadiene) 4.45 g (yield: 85%) was obtained as in Example 1 except that the amounts of 2,2-ditetrahydrofuryl propane, an n-hexane solution of n-BuLi (concentration: 1.50 mol/L) and phenylboronic anhydride were changed to 0.218 g (1.18 mmol), 1 ml (1.50 mmol) and 0.743 g (2.48 mmol), respectively, and a mixture of 13.3 g (36.9 mmol) of a 15 weight % n-hexane solution of 1,3-butadiene and 3.23 g (31.0 mmol) of styrene was used instead of styrene alone.

Mn: 11800

PDI: 1.0

Rf: 0.75

¹H-NMR (CDCl₃, 20° C.): δ=7.7 (br)

7.5 to 7.4 (br)

7.2 to 6.2 (br)

5.7 to 4.4 (br)

2.8 to 0.7 (br)

### Example 8

A colorless viscous liquid product having a terminal-B(p-CH₃C₆H₄)OH group (a terminal modified polystyrene-butadiene) 4.81 g (yield: 88%) was obtained as in Example 7 except that the amounts of 2,2-ditetrahydrofuryl propane, a 15 weight % n-hexane solution of 1,3-butadiene and styrene were changed to 0.223 g (1.21 mmol), 13.6 g (37.7 mmol) and 3.43 g (32.9 mmol), respectively, and 0.754 g (2.13 mmol) of p-methylphenylboronic anhydride was used instead of phenylboronic anhydride.

Mn: 13800

PDI: 1.0

Rf: 0.68

¹H-NMR (CDCl₃, 20° C.): δ=7.6 (br)

7.3 (br)

7.2 to 6.2 (br)

5.7 to 4.4 (br)

2.8 to 0.7 (br)

### Examples 9

A colorless viscous liquid product having a terminal-B(p-FC₆H₄)OH group (a terminal modified polystyrene-butadiene) 5.14 g (yield: 90%) was obtained as in Example 7 except that the amounts of 2,2-ditetrahydrofuryl propane, a 15 weight % n-hexane solution of 1,3-butadiene and styrene were changed to 0.283 g (1.53 mmol), 14.6 g (40.4 mmol) and 3.52 g (33.8 mmol), respectively, and 0.878 g (2.40 mmol) of p-fluorophenylboronic anhydride was used instead of phenylboronic anhydride.

Mn: 6260

PDI: 1.1

Rf: 0.77

¹H-NMR (CDCl₃, 20° C.): δ=7.9 (br)

7.5 (br)

7.2 to 6.2 (br)

5.7 to 4.4 (br)

2.8 to 0.7 (br)

Note that the amount (unit: mmol) of each reaction component used in each Example described above is shown in Table 1 below.

TABLE 1

| | Example | | | | | | | | |
|---|---|---|---|---|---|---|---|---|---|
| Reactants | 1 | 2 | 3 | 4 | 5 | 6 | 7 | 8 | 9 |
| Furyl propane | 1.32 | 1.33 | 1.33 | 1.18 | 1.13 | 1.53 | 1.18 | 1.21 | 1.53 |
| n-butyl Li | 3.14 | 3.14 | 3.14 | 1.50 | 3.00 | 1.50 | 1.50 | 1.50 | 1.50 |
| Styrene | 53.7 | 54.3 | 54.7 | — | — | — | 31.0 | 32.9 | 33.8 |
| Butadiene | — | — | — | 46.6 | 45.5 | 46.0 | 36.9 | 37.7 | 40.4 |
| Ph boronic anhydride | 4.97 | — | — | 3.04 | — | — | 2.48 | — | — |
| p-Me substitution | — | 5.34 | — | — | 5.45 | — | — | 2.13 | — |
| product thereof | | | | | | | | | |
| p-F substitution | — | — | 4.48 | — | — | 2.41 | — | — | 2.40 |
| product thereof | | | | | | | | | |

### Comparative Examples 1 to 6

The values of yield, Mn, PDI and Rf are shown in Table 2 below in a case where the terminal group of a —H group was obtained as in Examples 1 to 3, 4 to 6 and 7 to 9 except that various boronic anhydrides were not used (Comparative Examples 1 to 3), and the terminal group of —(CH₂)₃Si(OCH₃)₃ was obtained except that γ-chloropropyltrimethoxysilane (6.41 mmol) was used instead of various boronic anhydrides (Comparative Examples 4 to 6).

TABLE 2

| Comparative | Yield | | | |
|---|---|---|---|---|
| Example | (%) | Mn | PDI | Rf |
| 1 | 97 | 2820 | 1.1 | 0.89 |
| 2 | 85 | 9820 | 1.0 | 0.77 |
| 3 | 86 | 7820 | 1.1 | 0.79 |
| 4 | 91 | 3560 | 1.1 | 0.83 |
| 5 | 80 | 6270 | 1.1 | 0.83 |
| 6 | 88 | 7200 | 1.2 | 0.77 |

### Comparative Example 7

### Standard Example

| | | |
|---|---|---|
| SBR (Asahi Kasei Co., Ltd., E581) | 110.00 | parts by mass |
| (18.75 parts by mass of oil is added | | |
| to 50 parts by mass of SBR) | | |
| BR (Zeon Corporation, BR1220) | 20.00 | parts by mass |
| Silica (Rhodia operations, Zeosil Premium 200MP) | 80.00 | parts by mass |
| Carbon black (Tokai Carbon Co., Ltd., Seast KHP) | 5.00 | parts by mass |
| Stearic acid (NOF Corporation, YR) | 2.00 | parts by mass |
| Fatty acid ester (Schill & Seilacher, HT207) | 1.00 | parts by mass |
| Antioxidant DPPD (Solutia Europe, 6ppd) | 1.50 | parts by mass |
| Coupling agent (Evonik Degussa, Si69) | 6.40 | parts by mass |
| Process oil (Showa Shell Sekiyu K. | 5.00 | parts by mass |
| K., Extra No. 4S) | | |
| Zinc oxide | 3.00 | parts by mass |
| (Seido Chemical Industry Co., Ltd., | | |
| Zinc oxide No. 3) | | |
| Vulcanization accelerator A | 2.00 | parts by mass |
| (Sumitomo Chemical Industry Co., | | |
| Ltd., Soxinol D-G) | | |
| Vulcanization accelerator B | 1.70 | parts by mass |
| (Ouchi Shinko Chemical Industrial | | |
| Co., Ltd., Nocceler CZ-G) | | |
| Sulfur (Karuizawa Refinery, oil-treated sulfur) | 1.50 | parts by mass |

Among the above components, those except for the vulcanization accelerator and sulfur were kneaded for 5 minutes in a 1.7 L closed Banbury mixer, and the kneaded material was dumped out of the mixer to cool to room temperature. Subsequently, the vulcanization accelerator and sulfur were mixed with the same Banbury mixer. The resulting unvulcanized rubber composition was press vulcanized for 30 minutes at 150° C. to obtain a vulcanized rubber.

The unvulcanized rubber composition and the vulcanized rubber were measured for the following properties.
RPA (GCSWEEPSTD: the vulcanization Payne's effect):
   The unvulcanized rubber was vulcanized for 20 minutes at 160° C. A strain shear stress G′ (0.56%) at a strain of 0.56% and a strain shear stress G′ (100%) at a strain of 100% were measured to calculate the difference (absolute difference) between G′(0.56%) and G′(100%) using the resulting vulcanized rubber in accordance with ASTM D6204 using a RPA2000 (Alpha Technology strain shear stress measurement machine).
   The value of the Payne effect is an index with reference to Comparative Example 7. An index of less than 100 is preferred, and a smaller index means that the reduction or suppression of the Payne effect is better (the dispersibility of silane is better).
Hardness (20° C.): in accordance with JIS K 6253:2006 corresponding to ISO 48
   This hardness (20° C.) is expressed as an index where Comparative Example 7 is taken as 100.
   A larger value of this index indicates higher hardness and better steering stability.
Full automatic tensile tests: in accordance with JIS K 6251/6301:2006 corresponding to ISO 48
   Full automatic elongation (EB) and high temperature elongation (EB) are expressed as an index where Comparative Example 7 is taken as 100.
   A larger value of this index indicates better elongation of rubber.

### Comparative Example 8 and Reference Example

The products were obtained as in Comparative Example 7 except that 80.00 parts by mass of unmodified synthetic SBR (quenched by methanol; Comparative Example 8) or B terminal SBR (quenched by phenylboronic anhydride; Reference Example) was used instead of 110.00 parts by mass of SBR (Asahi Kasei Corporation E581), and 30.00 parts by mass of a process oil was further added.

The results obtained from Comparative Examples 7 to 8 and the Reference Example are shown in Table 3 below.

TABLE 3

| | Comparative | Comparative | Reference |
|---|---|---|---|
| Measurement Item | Example 7 | Example 8 | Example |
| RPA (vulcanization Payne effect) | 100 | 98 | 73 |
| Hardness (20° C.) | 100 | 111 | 118 |
| Full automatic elongation (EB) | 100 | 96 | 103 |
| High temperature elongation (EB) | 100 | 101 | 107 |

Note that 80.00 parts by mass was used to confirm the effect of phenylboronic anhydride-quenched SBR in the Reference Example. It was confirmed that a rubber composition having high hardness, large elongation and a high vulcanization Payne effect was obtained.

1. A terminal borinic acid group-modified polymer having a borinic acid group at least at a molecular terminus thereof, comprising a polymer of at least one of a styrene monomer and a diene monomer.

2. The terminal borinic acid group-modified polymer according to claim 1, wherein the styrene monomer is styrene or a derivative thereof.

3. The terminal borinic acid group-modified polymer according to claim 1, wherein the diene monomer is 1,3-butadiene or isoprene.

4. The terminal borinic acid group-modified polymer according to claim 1, which has a number average molecular weight Mn of 1,000 to 10,000,000.

5. A method of manufacturing a terminal borinic acid group-modified polymer, comprising performing a polymerization reaction of at least one of a styrene monomer and a diene monomer in the presence of an anionic polymerization initiator and then adding a cyclic boronic anhydride to quench the polymerization reaction.

6. The method of manufacturing a terminal borinic acid group-modified polymer according to claim 5, wherein the anionic polymerization initiator is n-butyl lithium or sec-butyl lithium.

7. The method of manufacturing a terminal borinic acid group-modified polymer according to claim 5, wherein the cyclic boronic anhydride is phenylboronic anhydride, or a p-methyl or p-fluoro substitution compound thereof.

8. A diene based rubber composition, wherein the terminal borinic acid modified-polymer according to claim 1 is compounded in a diene based rubber.

9. The diene based rubber composition according to claim 8, wherein 0.1 to 30 parts by mass of the terminal borinic acid modified-polymer is compounded in the total 100 parts by mass of the diene based rubber and the terminal borinic acid modified-polymer.

10. The diene based rubber composition according to claim 9, wherein 10 to 150 parts by mass of silica and 1 to 20 parts by mass of a silane based coupling agent are further compounded.

11. The diene based rubber composition according to claim 8, which is used for forming a cap tread part and/or a side tread part of a pneumatic tire.

12. A pneumatic tire having a cap tread part and/or a side tread part formed with the diene based rubber composition according to claim 11.

13. The diene based rubber composition according to claim 9, which is used for forming a cap tread part and/or a side tread part of a pneumatic tire.

14. The diene based rubber composition according to claim 10, which is used for forming a cap tread part and/or a side tread part of a pneumatic tire.

15. A pneumatic tire having a cap tread part and/or a side tread part formed with the diene based rubber composition according to claim 13.

16. A pneumatic tire having a cap tread part and/or a side tread part formed with the diene based rubber composition according to claim 14.
